(19) United States
(12) Patent Application Publication
(10) Pub. No.: US 2004/0080617 A1
(43) Pub. Date: Apr. 29, 2004

(54) Method and apparatus to improve picture aesthetics during switch-on

(75) Inventor: Andre Poelen, Groesbeek (NL)

Correspondence Address: PHILIPS INTELLECTUAL PROPERTY & STANDARDS, P.O. BOX 3001, BRIARCLIFF MANOR, NY, 10510, US

(73) Assignee: KONINLIJKE PHILIPS ELECTROICS N.V.

(21) Appl. No.: 10/281,827

(22) Filed: Oct. 28, 2002

(51) Int. Cl. H04N 3/20; H04N 5/63

(52) U.S. Cl. 348/173; 348/730

(57) ABSTRACT

A method and apparatus for suppressing aesthetic imperfections of a video signal when displayed on a cathode ray tube (CRT) display by compensating for both the picture tube characteristics (e.g. spread, temp drift and ageing of the red, green, blue amplifier and picture tube) and the temperature behavior (e.g. a warm and a cold picture tube start-up behavior) of the picture tube.

### FIELD OF THE INVENTION

The present invention pertains to televisions, and more particularly to a television having a switch-on procedure that suppresses of the aesthetic imperfections of a picture as the result of spread, temp drift and ageing of the red, green and blue (RGB) amplifier and picture tube.

### BACKGROUND OF THE INVENTION

After a television is switched on, the viewer has to wait several seconds until the picture becomes visible. As a result, the sound of the television is audible prior to the picture being visible. The viewer may become bored when the wait time (the time before the picture appears) is too long. However, if the picture is released too early, the picture is subject to being laden with aesthetic imperfections (e.g. bad picture quality). Attaining a picture free of imperfections with the shortest possible wait time is challenging because there is a large diversity in the switch-on conditions for conventionally manufactured televisions.

For example, the start-up phase of a television having a cathode ray tube (CRT) base display requires a warm-up time for the picture tube. Depending on the construction of the picture tube and environmental parameters, such warm-up time can take 5 to 10 seconds. During this time, the emission of electrons around the cathodes is undefined, that may result in a poor quality picture that is unfocused and discolored. In an attempt to avoid the poor picture quality during the start-up phase, the CRT is blanked until it is warmed.

During warming of a picture tube, the voltage/current (V/I) curve of the tube depends on how long the television has been switched off. For example, the start-up phase of a warm picture tube (such as the result of a quick switch-off and then on again) is different from the start-up behavior of a cold picture tube. A fixed delay for unblanking the picture tube after switching on or detection of a threshold current for unblanking in previous designs did not give the optimal start-up phase. Also the release of the picture (with a fixed delay) in combination with an in-range detector for the black current loops did not solve various problems experienced during the start-up phase.

Examples of patents that perform blanking of the picture include U.S. Pat. No. 5,194,954, issued to Duffield, entitled “AUTOMATIC CHANNEL SAMPLING PICTURE-IN-PICTURE CIRCUITRY”; U.S. Pat. No. 4,748,497, issued to Sengoku, entitled “TELEVISION RECEIVER AUTOMATIC COLOR TEMPERATURE ADJUSTING SYSTEM WITH START UP CONTROL”; U.S. Pat. No. 4,188,641, issued to Baker et al., entitled “STARTUP CIRCUIT FOR A TELEVISION RECEIVER”; and U.S. Pat. No. 4,129,885, issued to Chovanec, entitled “WARM-UP COMPENSATION SYSTEM FOR PICTURE TUBE” none of which meet the needs of the present invention.

As will be seen more fully below, the present invention is substantially different in structure, methodology and approach from that of prior switch-on procedures that blank the picture in televisions upon start-up.

### SUMMARY

The present invention provides a start-up procedure and circuit that minimizes the time before release of a video signal to the television or picture tube without having significant aesthetic imperfections. The television start-up control circuit compensates for both the picture tube characteristics (e.g. spread, temp drift and ageing of the red, green, blue amplifier and picture tube) and the temperature behavior (e.g. a warm and a cold picture tube start-up behavior) of such picture tube.

In one embodiment, a last stored gain setting stored when the television was switched “OFF” is used to control the video signal and stabilize the cathodes cutoff and drive level when the television is switched “ON”. Such gain setting is independent of the picture tube characteristics (e.g. spread, temp drift and ageing). In another embodiment, a prediction can be made using start-up curves that are fixed by these characteristics and temperature behaviors to achieve an optimal start-up behavior when the television is switched “ON”.

### BRIEF DESCRIPTION OF THE DRAWINGS

FIG. 1 illustrates a general schematic diagram of the television start-up control circuit for a television according to the present invention.

FIG. 2 illustrates a graphical representation of the different release moments of the picture after switch-on of a warm and cold picture tube with suppression of the aesthetic imperfections.

FIG. 3 illustrates a general flowchart of the start-up phase according to the present invention.

FIG. 4A illustrates the switching diagram for the offset-loop measurements in accordance with the present invention.

FIG. 4B illustrates the switching diagram for the gain-loop measurements in accordance with the present invention.

FIG. 4C illustrates the switching diagram for the start-up phase in accordance with the present invention.

FIG. 5 illustrates a general flowchart of a second embodiment of the start-up phase according to the present invention.

### DETAILED DESCRIPTION OF THE INVENTION

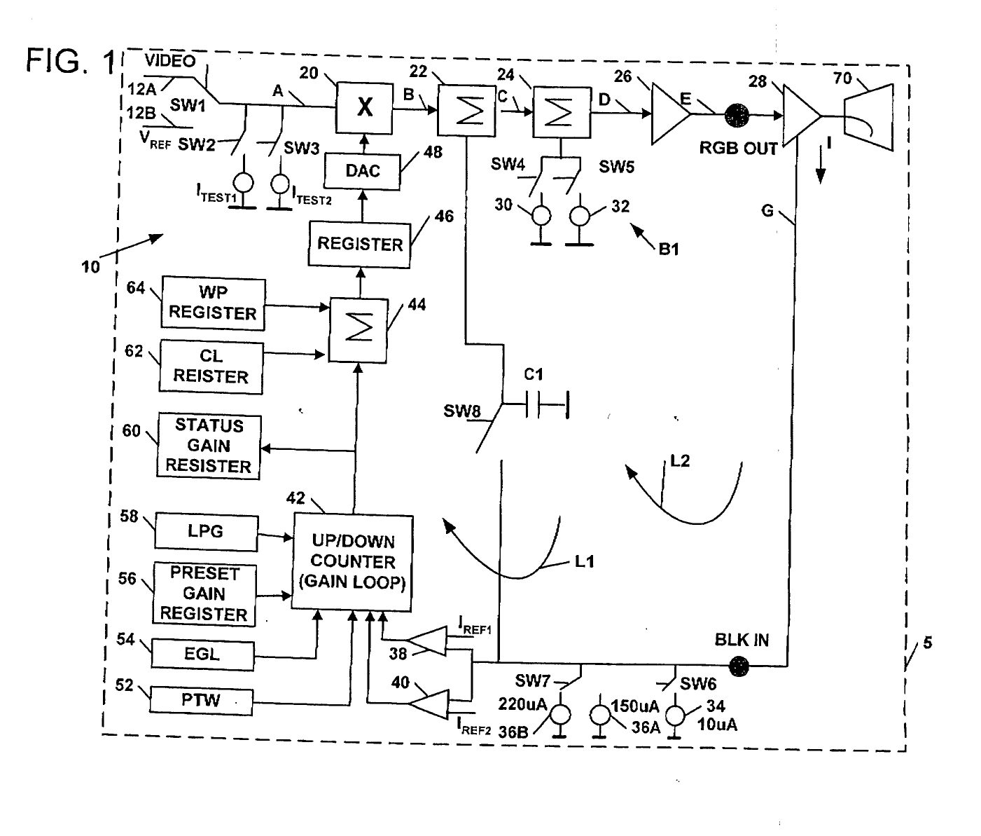

Referring now to FIG. 1, the television start-up control circuit 10 includes a gain loop L1, an offset loop L2 and blanking control sub-circuit B1 to suppress aesthetic imperfections of a picture resulting from spread, temperature drift and ageing of the red, green and blue (RGB) amplifier 28 and picture tube 70. The television start-up control circuit 10 provides continuous cathode calibration with an offset loop L2, during every even field, and a gain loop L1, during every odd field. The feedback signal in offset loop L2 is an analog signal. During every even field, a measurement of a 10 uA point is performed to stabilize the cutoff of the three cathodes. The hold time is short due to the capacitor C1 in the offset loop L2. The drift in cutoff can be very fast due to picture content changes.

On the other hand, the feedback signal in gain loop L1 is a digital signal whose output is converted to an analog signal. During every odd field, a measurement of a reference current 150 or 220 uA point is performed to stabilize the drive of the three cathodes. It is not necessary to perform a measurement every 40 msec because the hold time is relatively long due to the digital-to-analog converter (DAC) 48 in the gain loop L1. Moreover, the drift in gain is relatively very slow.

Referring still to FIG. 1 the schematic diagram of the television start-up control circuit 10 will now be described in detail for a television 5. The television start-up control circuit 10 comprises a video input source (video) on line 12a and a voltage reference source (Vref) on line 12b. The line 12a and line 12b are coupled to switch SW1. Switch SW1 has an output on line a. Line a has coupled thereto first and second test current reference sources Itest1 and Itest2 via switches SW2 and switch SW3, respectively.

The input source, on line a, is also coupled to the multiplier 20 (hereinafter referred to as the “gain-loop multiplier 20”). The output from the gain-loop multiplier 20, on line b, is coupled to the input of summer 22 (hereinafter referred to as the “offset-loop summer 22”). The output from the offset-loop summer 22, on line c, is input into the summer 24 (hereinafter referred to as the “blanking summer 24”) of the blanking control sub-circuit B1. The output from the blanking control sub-circuit B1, on line d, is input to the current-to-voltage converter 26. The output of the current-to-voltage converter 26, on line e, is input into the RGB amplifier 28. The output from the RGB amplifier 28 is sent to picture tube 70 in the television 5.

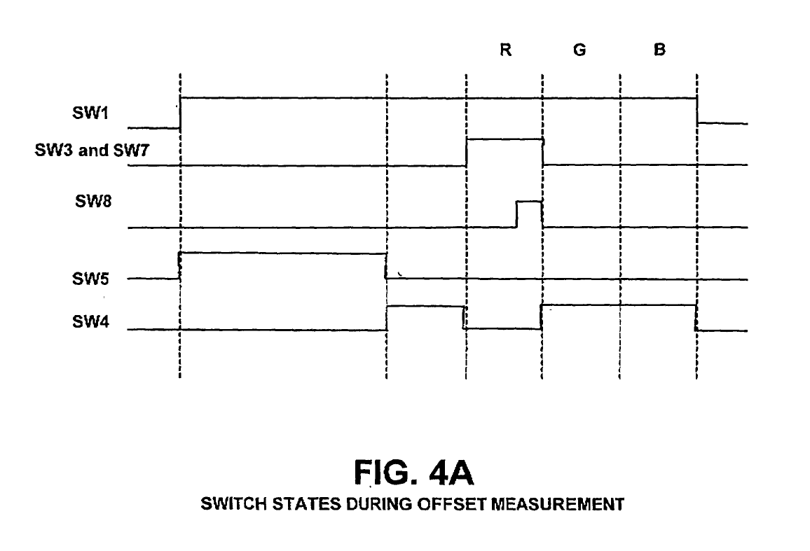

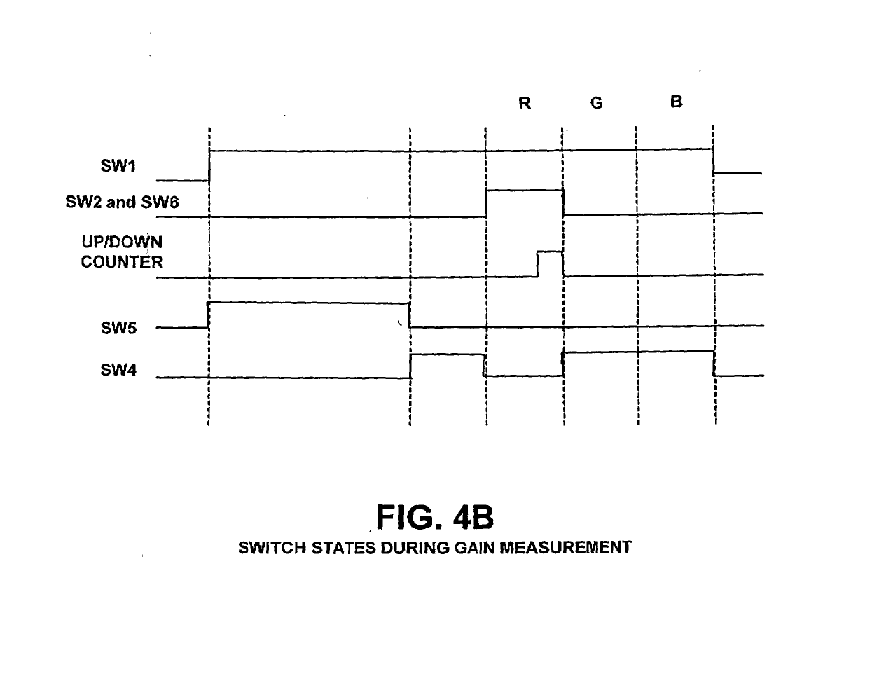

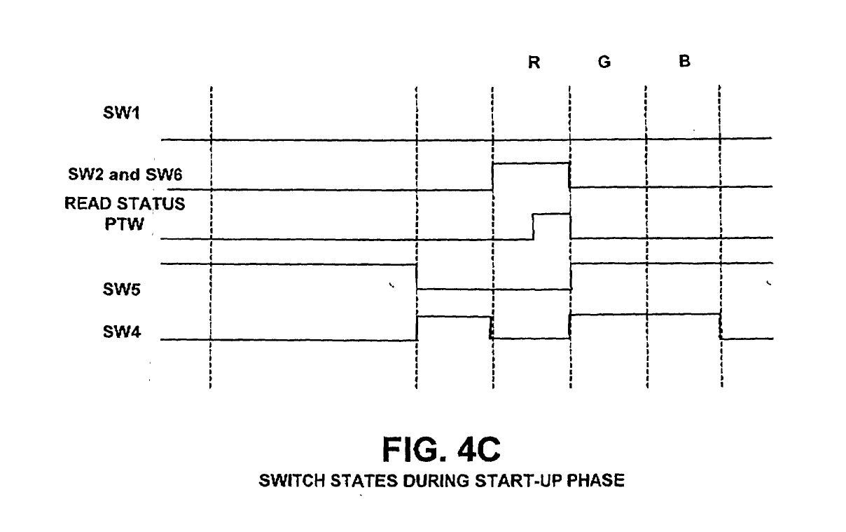

The blanking control sub-circuit B1 will now be described in detail. The blanking control sub-circuit B1 includes first and second blanking current reference sources 30 and 32. The first and second blanking current reference sources 30 and 32 are coupled to first and second switches SW4 and SW5, respectively. During the start-up phase, the picture is blanked by blanking control sub-circuit B1 in accordance with the switch states shown in FIGS. 4A, 4B and 4C.

The black current loops (e.g. the gain loop L1 and the offset loop L2) will now be described in detail. A feedback current I, on line g, from the RGB amplifier 28 feeds the gain loop L1 and the offset loop L2. In an exemplary embodiment of the present invention, a reference current from current source 34 provides a 10 μA current and is switched on via switch SW6. The feedback current I, on line g, flows through switch SW8 and to the offset-loop summer 22 via capacitor C1 when the gain loop L1 in inactive and the offset loop L2 is active. The capacitor C1 is coupled to ground and between switch SW8 and the offset-loop summer 22.

In general, the function of the offset loop L2 is stabilization of the cut-off voltage of the cathodes of the CRT. The cut-off measurement is performed during three successive lines in the overscan every even field (40 msec.). The loop is continuously calibrating because the voltage grid 2 (VG2), which is part of the picture tube 70, depends upon the load of the high tension voltage (EHT). For television applications, the EHT may be approximately 30 kV.

When the gain loop L1 is active, the feedback current I, on line g, feeds into first and second op-amps 38 and 40 which receive reference currents Iref1 and Iref2, respectively. The first op-amp 38 feeds into the up/down counter 42. The output of op-amp 40 feeds both the up/down counter 42 and the picture tube warm (PTW) register 52. The operation of the first and second op-amps 38 and 40 in the gain loop L1 is set forth below in TABLE 1.

The up/down counter 42 receives as input the register contents of the loaded preset gain (LPG) register 58, preset gain register 56, the enable gain loop (EGL) register 54 and the PTW register 52. The output of the up/down counter 42 is sent to the summer 44. Summer 44 also receives as input the register contents of the white point (WP) RGB adjustment register 64. The WP register 64 and the cathode drive level register (CL) register 62 store data prestored by the manufacturer, and are used on the production line during the manufacturing process to align the television according to manufacturer specification.

In operation, when the gain loop L2 is enabled and the feedback current, on line g, is too low (lower than Iref1), the up/down counter 42 counts up and increases the output to the gain-loop multiplier 20, via DAC 48, until the feedback current, on line g, is above Iref1. The PTW register 52 is high if I input is >5 uA (the feedback current exceeds the chosen offset current of 150 or 220 μA) and low if I input is <5 uA. The status of the PTW register 52 is based on the output of op-amp 40. Switch SW 7 is adapted to switch between two current sources 36a and 36b. In the exemplary embodiment, the two current sources 36a and 36b are 220 μA and 150 μA, respectively.

The gain loop L1 stabilizes the white point of the picture tube 70. Therefore, the gain becomes independent upon spread, temp drift and ageing of the red, green and blue (RGB) amplifier 28 and picture tube 70. The gain loop L1 is activated with bus bit from the EGL register 54 and adjusts the gain during the odd field in three successive lines. Preferably, the gain loop L1 will be only active at certain short moments, e.g. during channel switching to prevent interaction between the gain loop L1 and the offset loop L2 and the visibility of the test lines.

In an exemplary embodiment, the reference current Iref1 of the gain loop L1 is optional between 200 and 150 μA. The result of the gain measurement is stored in the status gain measurement register 60 and will be stored in external memory during the switch-off mode and will be loaded in the preset gain register 56 after the television is switched “ON” again.

The white point RGB adjustment register 64, the cathode drive level register 62 and the status gain measurement register 60 are combined via summer 44 and stored in register 46 to drive the gain multiplier 20 via the digital-to-analog converter (DAC) 48 to get optimal signal-to-noise ratio (SIN) for the video signal, on line a, from video source 12a.

When the preset gain is loaded, the gain loop L1 is disabled. When the EGL is enabled the gain loop is enabled. The gain of the loop is controlled by the value in the up-down counter 42.

### Gain-Loop

Referring now to FIG. 4B, the states of switches SW1, SW2, SW4, SW5, SW6 and the up/down counter 42 for the gain-loop L1 measurements are shown. When the gain loop is active, the EGL register 54 equals “1” (EGL=1) and the LPG register 58 equals “0” (LPG=0). During three successive lines, just before the end of the vertical blanking the gain measurements are performed every odd field or every other field. During the test line the feedback current I is checked in accordance with parameters set forth in TABLE 1.

TABLE 1

| | | | Up/Down Counter |
|---|---|---|---|
| I input | Upper Level | Lower Level | Action |
| < −5 μA | 0 | 0 | Count Up |
| > −5 μA, <5 μA | 0 | 1 | Hold |
| >5 μA | 1 | 0 | Count Down |

The preset gain registers 56 are inputs (read) into the gain loop L1 and the status registers 60 are outputs (write) from the gain loop L1. The status of the gain can be loaded in external memory (values can be held during switch off condition) and be reloaded in the preset gain registers during switch on.

### Offset-Loop

Referring now to FIG. 4A, the states of switches SW1, SW3, SW4, SW5, SW7 and SW8 for the offset loop L1 measurements are shown. When the offset-loop L2 is active, the gain-loop L1 is not active. The offset loop is active in one field and the gain loop can be active in the other field. The offset loop controls the cutoff levels of the three channels. During three successive lines, just before the end of the vertical blanking the offsets measurements are performed. When the offset-loop L2 is active, the EGL register 54 equals “0” (EGL=0) and the LPG register 58 equals “1” (LPG=1). The up/down counter 42 is not active. The feedback current, on line g, is not checked for gain settling. However, the values present in the preset gain registers 56 are loaded in the up/down counter 42 to control the gain of the gain-loop multiplier 20.

### Start-Up Phase

Referring now to FIG. 4C, the states of switches SW1, SW2, SW4, SW5, SW6 and the read status of the PTW register 52 for the start-up phase are shown. During the start-up phase, the EGL register 54 equals “1” (EGL=1) and the LPG register 58 equals “1” (LPG=1). The test lines are available, but the gain loop L1 is not active. Instead, the gain of the gain loop L1 is fixed by the preset gain values in the preset gain register 56. The status bit in the PTW register 52 becomes high (“1”) when I input>5 μA.

The present gain register 56 is loaded with the information in the status gain register 60 when the television is switched “ON” during the start-up phase. For simplicity of design of circuit 10, it is assumed the status registers 60 are part of external memory. When the television is switched “OFF”, the values of the status registers 60 are stored in the external memory. After the television is switched “ON”, the values stored in the external memory are loaded in the preset gain registers 56 and can be used to define the software start-up algorithm before the picture is released.

In operation during the start-up phase, switch SW1 disables the video during the vertical blanking period and blanking is inserted by switch SW5 except during the test lines. During three successive lines, just before the end of the vertical blanking the gain measurements are performed. In one field the offset loop controls the cut-off of the cathodes of the CRT, and in the other field, the gain (drive level) of the cathodes is stabilized. Test pulses are generated internally by with switches SW2 and SW3. During the start-up phase, the EGL equals “1”, the LPG equals “1”, and the value of the preset gain registers 56 equals the previous value of the status register+“x”, wherein the value of x is fixed by the customers' software. The software start-up algorithm determines the value of “x”. When the input current exceeds 5 μA during the RED gain measurement the PTW status bit toggles from “0” to “1”.

In the start-up procedure according to the present invention, the time before release of the picture tube can be minimized without having aesthetic imperfections. In conventional start-up systems, such solutions did not generally distinguish between the picture tube characteristics (e.g. spread, temp drift and ageing of the RGB amplifier 28 and picture tube 70) and temperature behavior (e.g. a warm and a cold picture tube start-up behavior). By predicting the start-up curve which is fixed by these characteristics and temperature behavior it is possible to achieve an optimal start-up behavior for the varying characteristics and temperature behavior.

During the start-up phase, the picture is blanked by blanking control sub-circuit B1 and only in the vertical interval (overscan) where test lines are generated for the black current loops during the offset loop L2. During the start-up phase, the gain loop L1 is used to check if the picture tube 70 is (almost) warm or predict the start-up curve. The level of the test pulses at the RGB outputs can be chosen by software with the WP register 64, the CL register 62 and the status gain measurement register 60.

The television manufacturer can do one simple check to release the picture. At a certain test voltage, free to be chosen by software, the feedback current of the picture tube 70 is checked. The PTW (Picture Tube Warm) register 52 becomes “1” when the feedback current exceeds the chosen offset current of 150 or 220 μA. After reloading the memory setting, the picture can be released with or without an additional fixed delay period.

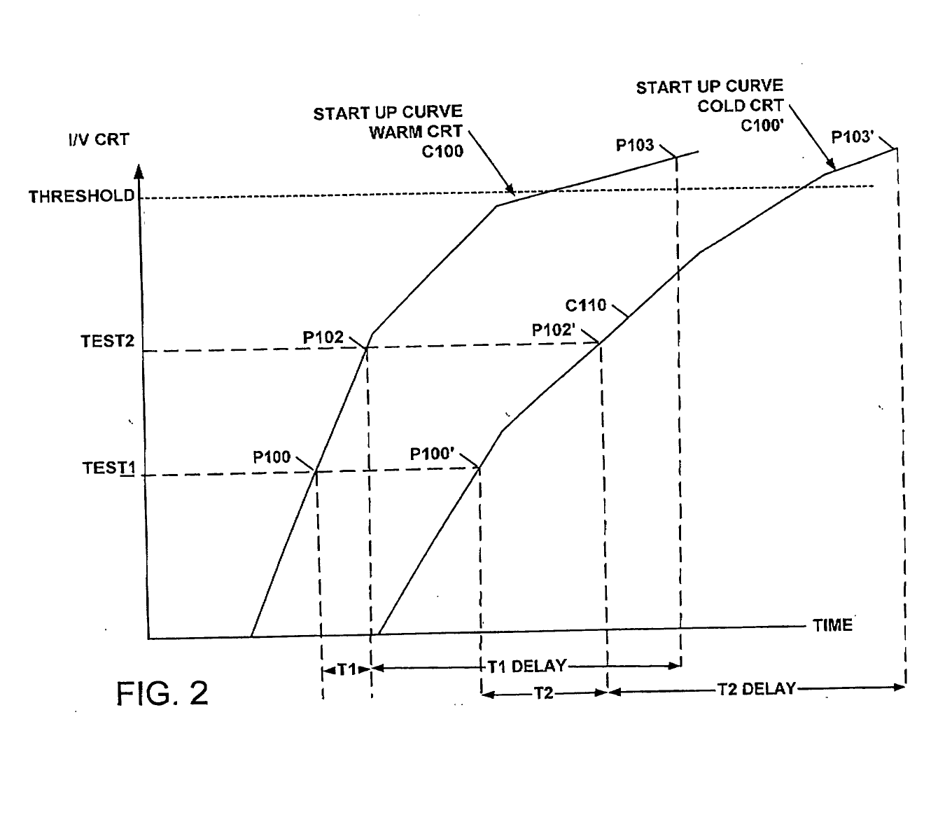

Referring now to FIG. 2, for better prediction, using stored start-up curve data, two crossing points are generated by performing two checks (e.g. at test 1 and test 2). Thereafter using the measurement results of test 1 and test 2, the optimum release moment (tx delay) and conditions of the picture tube are calculated. Test 1 and test 2 are checks on PTW with different preset values (stored and determined via a software algorithm) to control the gain multiplier 20.

The curves of FIG. 2 show different release moments of the picture after the television is switched “ON” on a warm and cold picture tube 70 with suppression of the aesthetic imperfections. Curve C100 is an exemplary start-up curve for a warm CRT. Curve C110 is an exemplary start-up curve for a cold CRT.

When performing test 1 and test 2 on a warm CRT, points P100 and P102 are created. The difference in time between points P100 and P102 is time T1. As can be readily seen, if the manufacturer wanted to release the picture when the characteristics of the picture tube 70 reached point P103, the circuit 10 would release the blanking after time T1 delay (optimum release moment), wherein the time T1 delay is the difference in time between point P102 and point P103.

When performing test 1 and test 2 on a cold CRT points P100′ and P102′ are created. The difference between points P100′ and P102′ is time T2. As can be readily seen, if the manufacturer wanted to release the picture when the characteristics of the picture tube 70 reached point P103′, the circuit 10 would release the blanking after time T2 delay (optimum release moment), wherein the time T2 delay is the difference in time between point P102′ and point P103′ on the cold CRT start up curve C110.

### Start-Up Procedure

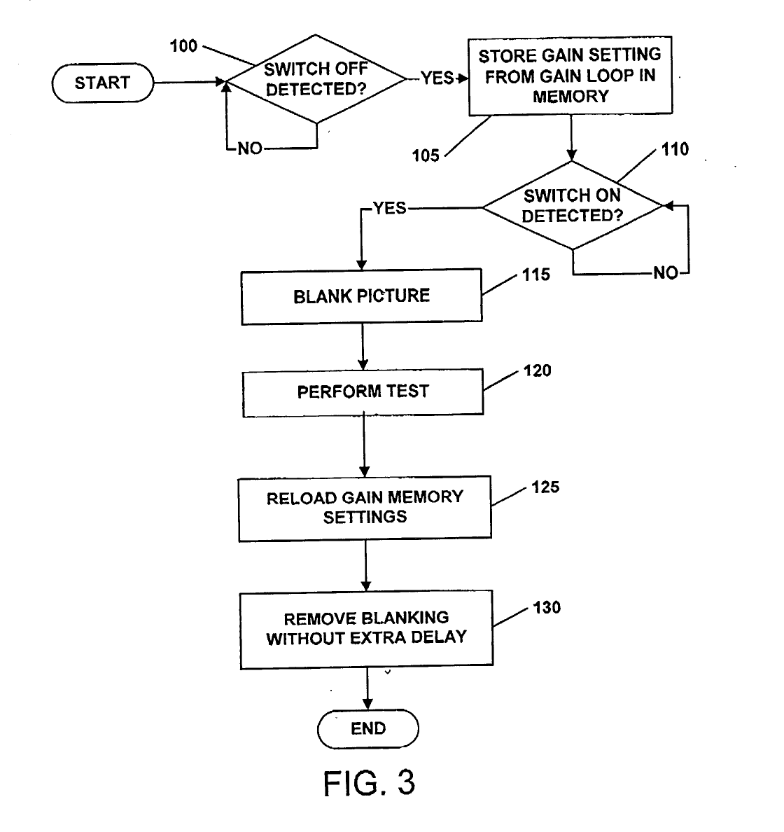

Referring now to FIG. 3, the general flowchart of the start-up procedure in accordance with the present invention is shown and begins at Step 100. At Step 100, a switch “OFF” condition is determined. Step 100 is followed by Step 105 where the gain setting is stored. Step 105 is followed by Step 110 where a switch “ON” condition is determined. Step 110 is followed by Step 115 where the picture is blanked during start-up as the television is switched “ON”. Step 115 is followed by Step 120 where a test voltage or test line is applied during vertical interval (overscan) to stabilize the cutoff via the offset loop L2. When applying the test voltage or test line, LPG is set to “1” and the gain of the loop is fixed such that the preset value register 56 is set equal to the preset value stored in external memory+“x”. The EGL is set to “1”; and the test lines are automatically generated.

Step 120 is followed by Step 125 where the PTW becomes “1” and the memory settings are reloaded. Step 125 is followed by Step 130 where the picture is released and the blanking is removed without any additional delay. The preset value in the preset gain register 56 equals the original preset value. Furthermore, the EGL register 54 is set equal to “0” (optional) and the LPG register 58 is set equal to “0”.

In an alternative embodiment, the blanking can be removed after a predetermined fixed delay established by the manufacturer in lieu of without additional delay.

During normal operations, the external memory settings are equal to the last results of the status bits. Only during the start-up phase will the preset gain value differ from the status bits to ensure that the feedback current exceeds the offset current so that the PTW register 52 becomes “1”.

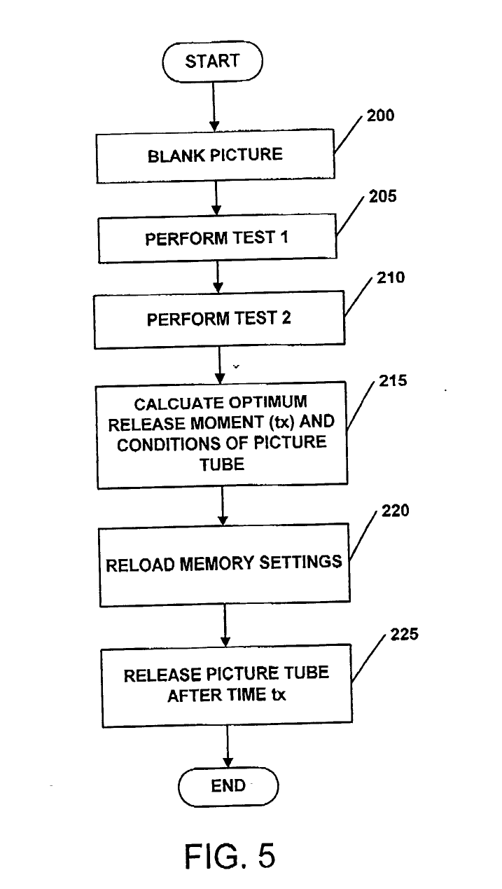

Referring now to FIG. 5, there is shown a general flowchart of a start-up procedure in accordance with present invention using the curves of FIG. 2 that begins at Step 200. At Step 200, the picture is blanked during start-up. During start-up, the television has been switched “ON”. Step 100 is followed by Step 205 where a first test voltage or test lines is applied during vertical interval (overscan). When applying the test voltage or test line, LPG is set to “1” and the gain of the loop is fixed. The preset value equals the preset value+“x”. The EGL is set to “1” and the test lines are automatically generated. Step 205 is followed by Step 210 where a second test is performed using a different preset value. Step 210 is followed by Step 215 where an optimum release moment tx and conditions of the picture tube 70 are calculated.

During test 1 at Step 205, a first test voltage or test line during vertical interval (overscan) is applied. This is automatically done with LPG=1 and EGL=1 and the preset value equals the preset value+“x1”. During test 1, the PTW register 52 is checked. During test 2 at Step 210, a second test voltage or test line during vertical interval (overscan). Here, the preset value is equal to the preset value+“x2”. Again during test 2, the PTW register 52 is checked.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A method for improving a video signal when a television display is switched on, comprising the steps of:
storing a gain setting for a television display when a switch off condition of the display is detected;
upon detecting a switch on condition, blanking a video signal to the display;
applying the stored gain setting to adjust the video signal and adjust the cutoff of a cathode of the display; and
unblanking the gain adjusted video signal to the display.

2. The method according to claim 1, wherein the stored gain setting suppresses aesthetic imperfections of the video signal as the result of spread, temp drift and ageing of a red, green and blue amplifier and picture tube of the display.

3. The method according to claim 2, further comprising the step of calibrating the cathode.

4. The method according to claim 3, wherein the cathode calibration step comprises the steps of:
during every even field, performing an offset measurement to stabilize cutoff of the cathode of the picture tube; and
during every odd field, performing a gain measurement to stabilize a drive level of the the cathode.

5. The method according to claim 4, wherein the offset measurement step comprises the step of applying a test line during a vertical interval.

6. The method according to claim 5, wherein the gain measurement step commences during channel switching to prevent interaction with the offset measurement step and the visibility of the test line.

7. A method for improving a video signal when a television display is switched on, comprising the steps of:
upon detecting a switch on condition, blanking a video signal to a television display;
predicting a release moment to release the video signal; and
unblanking the video signal to the television display at a predicted release moment.

8. The method according to claim 7, wherein the predicting step comprises the steps of:
performing a first test using a first preset gain setting;
performing a second test using a second preset gain setting; and
calculating a release moment based upon results of the first test and the second test.

9. The method according to claim 8, further comprising calculating the gain setting for the release moment wherein the gain setting is equivalent to the previous gain incremented by additional gain such that PTW is one.

10. The method according to claim 9, wherein the calculating step is a function of a start-up warm curve or a start-up cold curve for a cathode ray tube.

11. The method according to claim 9, wherein the calculated release moment and the calculated gain setting suppresses aesthetic imperfections of the picture as the result of spread, temperature drift and ageing of a red, green and blue amplifier and picture tube of the television display.

12. The method according to claim 7, further comprising the step of calibrating a cathode.

13. The method according to claim 12, wherein the cathode calibration step comprises:
during every even field, performing an offset measurement to stabilize cutoff of the cathode of the picture tube; and
during every odd field, performing a gain measurement to stabilize a drive level of the cathode.

14. The method according to claim 13, wherein the offset measurement step comprises the step of applying a test line during a vertical interval.

15. The method according to claim 14, wherein the gain measurement step commences during channel switching to prevent interaction between the offset measurement step and the visibility of the test line.

16. A television display apparatus, comprising:
means for blanking a video signal to a television display when a switch on condition is detected;
means for predicting a release moment to release the video signal; and
means for unblanking the video signal to the display at a predicted release moment.

17. The apparatus according to claim 16, wherein the predicting means comprises:
means for performing a first test using a first preset gain setting;
means for performing a second test using a second preset gain setting; and
means for calculating the release moment based upon results of the first test and the second test.

18. The apparatus according to claim 17, further comprising means for calculating the gain setting for the release moment.

19. The apparatus according to claim 18, wherein the calculated release moment and the calculated gain setting suppresses aesthetic imperfections of the picture as a result of spread, temperature drift and ageing of a red, green and blue amplifier and picture tube of the television display.

20. The apparatus according to claim 16, further comprising.
means for performing an offset measurement to stabilize cutoff of three cathodes of the picture tube during every even field; and
means for performing a gain measurement to stabilize a drive level of the three cathodes during every odd field.
